(19) United States
(12) Patent Application Publication
(10) Pub. No.: US 2008/0267002 A1
(43) Pub. Date: Oct. 30, 2008

(54) Method for Dosing Additive in Injection-Moulding Unit, and Injection-Moulding Unit

(75) Inventor: Kari Rannasmaa, Reijola (FI)

Correspondence Address: YOUNG & THOMPSON, 209 Madison Street, Suite 500, ALEXANDRIA, VA, 22314, US

(73) Assignee: MEDIFIQ HEALTHCARE OY, VANTAA (FI)

(21) Appl. No.: 12/093,455

(22) PCT Filed: Nov. 14, 2006
(86) PCT No.: PCT/FI2006/050495

§ 371 Date: May 13, 2008

(30) Foreign Application Priority Data
Nov. 16, 2005 (FI) 20055605

(51) Int. Cl. B29C 45/18

(52) U.S. Cl. 366/78; 366/76.1

(57) ABSTRACT

A method for dosing an additive in an injection-moulding unit, and an injection-moulding unit. The injection-moulding unit (1) comprises a screw (2) that comprises at least a feed zone (4). The injection-moulding unit (1) also comprises feed devices (7) that dose the plastic raw material into a space between the screw (2) and a cylinder through a feed opening (9) onto the feed zone (4) of the screw. The additive is fed to the feed zone (4) of the screw from the dosing channel (10) that opens into the space between the screw (2) and cylinder (3) in the flow direction of the plastic raw material.

### BACKGROUND OF THE INVENTION

The invention relates to a method for dosing an additive in an injection-moulding unit that comprises a screw that is arranged to rotate and reciprocate in a cylinder and is divided in the longitudinal direction into a feed zone, compression zone and homogenisation zone, and in a space between the screw and cylinder, the flow properties of a plastic raw material are plasticized to an appropriate level; feed devices that dose the plastic raw material into the space between the screw and cylinder though a feed opening onto the feed zone of the screw; and the injection-moulding unit has two main operational steps, i.e. a plasticizing step and injection step, and in the plasticizing step, the screw is arranged to reverse in the cylinder and obtain in front of it a sufficient amount of the plastic raw material for the injection step, and in the injection step, the screw advances pushing the plasticized raw material out of the cylinder.

The invention further relates to an injection-moulding unit that comprises a screw that is arranged to rotate and reciprocate in a cylinder and comprises a feed zone, feed devices having a feed opening through which a plastic raw material is fed to a space between the screw and cylinder on the feed zone of the screw, and the screw is arranged to reverse in the cylinder and obtain in front of it a sufficient amount of the plastic raw material for the injection step, after which the screw is arranged to advance in the cylinder and push the plasticized raw material into an injection channel.

Injection moulding is among the most important manufacturing techniques of thermoplastics due to the fact, among other things, that it permits the manufacture of even complex products quickly and cost-effectively.

The manufacture of some injection-moulded products requires the addition of an additive or additives into the basic raw material, i.e. the plastic raw material. The additive is mixed in small quantities into the plastic raw material and is another ingredient in the final injection-moulded product and affects the functionality of the injection-moulded product. One example of an additive is a lubricant that reduces the friction coefficient of the surface of the injection-moulded product.

In known methods and injection-moulding devices, the additive is supplied with the plastic raw material—that is usually in granulate form—into the injection-moulding machine. In most cases this principle works well when the additive needs to be mixed evenly into the volume of the plastic material forming the product.

However, the situation changes if the additive should be mixed into the plastic raw material in such a manner that, due to functional reasons, the content of the additive is higher in one part of the product than in another part of the same product, and yet if the additive is by nature such that it mixes poorly with the plastic raw material to be injection-moulded. This type of additive seeks to form precipitations inside the injection-moulded product or build-ups on the surface of the injection-moulded product. The precipitations and build-ups cause visual defects, due to which a considerable number of the manufactured products do not meet the quality criteria and have to be rejected. Precipitations and build-ups also cause functional problems: an uneven distribution of an additive reducing the friction coefficient of the product surface can for instance lead to not having a sufficiently low friction coefficient everywhere on the surface of the product. This results in the rejection of the product. This also creates a need to increase the additive content in the plastic raw material, which in turn increases the raw material costs caused by the additive and may even result in a reduction in the mechanical strength of the product.

### BRIEF DESCRIPTION OF THE INVENTION

It is an object of the present invention to provide a novel and improved method and injection-moulding unit, with which to reduce the above-mentioned problems.

The method of the invention is characterized by feeding an additive to the feed zone of the screw from a dosing channel that opens into the space between the screw and cylinder after the feed opening in the flow direction of the plastic raw material.

The injection-moulding unit of the invention is characterized in that it comprises a dosing channel leading through the cylinder wall and arranged after the feed opening in the flow direction of the plastic raw material, the dosing channel being connected to the additive container for feeding the additive to the feed zone of the screw.

The essential idea of the invention is that the additive is supplied to the feed zone of the screw from a channel that is arranged in the cylinder of the injection-moulding machine at a distance from the feed opening of the plastic raw material after the feed opening in the flow direction of the plastic raw material.

The invention provides the advantage that the additive is mixed into the plastic raw material in such a manner that it does not necessarily disperse evenly into the entire plastic raw material and the volume of the plastic product to be moulded, but its content is unexpectedly at its highest on the surface of the product. This is advantageous especially when the additive on the surface or surface parts of the product provides the product with a functional or other advantage, but does not provide any advantage—or is even harmful—when in the inner parts of the plastic material forming the product. Another advantage is that with the invention, it is possible to reduce the amount of the required additive, which reduces costs and the creation of visual defects—especially if the additive is by nature such that it mixes poorly with the used plastic raw material.

An essential idea of an embodiment of the invention is that the additive is a lubricant that reduces the friction coefficient of the surface of the injection-moulded product. The lubricant content should be high on the surface of the product and as low as possible in the inside of the product where no surfaces exist that may contact other surfaces.

An essential idea of an embodiment of the invention is that the additive is fed into the plastic raw material only during the plasticizing step. Because of this, it is possible to dose the additive as evenly as possible therein.

### BRIEF DESCRIPTION OF THE FIGURES

Some embodiments of the invention are described in more detail in the attached drawings, in which

FIG. 1 is a partially cross-sectional schematic view of an injection-moulding unit of the invention from the side and with the screw in its front position,

FIG. 2 is a partially cross-sectional schematic view of the injection-moulding unit of FIG. 1 from the side and with the screw moving backward from the front position to the back position, and

FIG. 3 is a partially cross-sectional schematic view of the injection-moulding unit of FIG. 1 from the side and with the screw in its back position.

In the figures, some embodiments are shown in a simplified manner for the sake of clarity. Similar parts are marked with the same reference numbers in the figures.

### DETAILED DESCRIPTION OF SOME EMBODIMENTS OF THE INVENTION

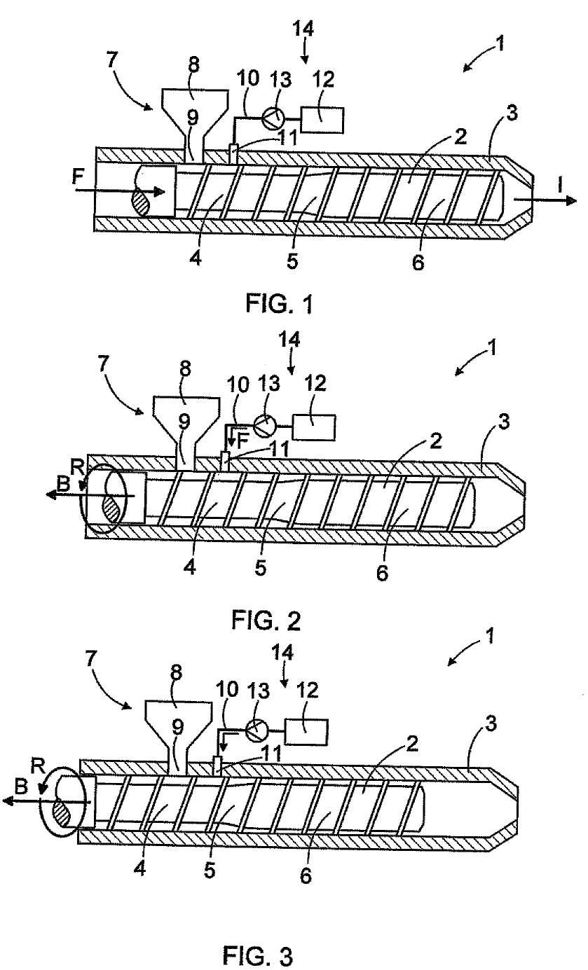

FIG. 1 is a partially cross-sectional schematic view of an injection-moulding unit of the invention from the side and with the screw in its front position, FIG. 2 shows the injection-moulding unit of FIG. 1 in partial cross-section from the side and with the screw moving backward, and FIG. 3 shows the same injection-moulding unit schematically in partial cross-section from the side and with the screw in its back position.

The injection-moulding unit 1 comprises a screw 2 and cylinder 3. The screw 2 is an injection-moulding machine screw known per se that comprises a thread for transporting material. The screw 1 is arranged in a manner known per se to be rotatable and movable in its longitudinal direction in the cylinder 3. The screw 2 shown in the figures is a standard screw that in its longitudinal direction can be divided into three zones: feed zone 4, compression zone 5, and homogenization zone 6. The screw 2 may also contain other zones, such as a gas discharge zone in a gas discharge screw. The screw can be equipped with heat regulation means, such as liquid circulation channels, but this is not absolutely necessary.

It should be noted that dimensions of the screw 2 shown in the figure are only given by way of example and that the design and dimensions of the screw 2 are selected on the basis of the properties of the material and product to be injection moulded. The length of the screw may be 20:1 to 22:1, for instance, given by means of the diameter of the screw.

The cylinder 3 is typically, but not necessarily, equipped with heat regulation means that control the temperature of the plastic raw material in the cylinder 3. The heat regulation means may be electric resistors, for instance, that heat the injection-moulding unit to a suitable temperature. The cylinder 3 is usually divided into two or more temperature zones whose temperatures can be regulated independently. It should be noted that the heat regulation means are not shown in the figure to simplify the presentation.

The injection-moulding unit 1 also comprises feed devices 7 for feeding the plastic raw material to be injection-moulded in the injection-moulding unit 1 into the space between the screw 2 and cylinder 3. The feed devices 7 belonging to the injection-moulding unit 1 of FIG. 1 comprise a feed funnel 8 and a feed opening 9 through the wall of the cylinder 3. The plastic raw material that is in granulate form travels from the feed funnel 8 to the feed opening 9 and on to the space between the screw 2 and cylinder 3 to the feed zone of the screw 2. Such feed devices 7 are known per se to a person skilled in the art, so they are not discussed in more detail herein.

The screw 2 moves the plastic raw material from the feed zone 4 to the compression zone 5 and on to the homogenization zone 6. In the feed zone 4, the plastic raw material has ample space and is in granulate form. The feed zone thus serves as the conveyor of solid-state raw material. The profile of the screw 2 is high in this part so that a large mass flow is possible despite the fact that the plastic raw material is in a form that requires a lot of space. The plastic raw material begins to lose its granulate form in the compression zone 5 where it encounters pressure, friction and external thermal energy. The homogenization zone 6 mixes the melted plastic raw material suitable for injection into a mould in the actual injection event. The operation of the screw 2 is known per se, so it is not discussed in more detail herein. The plastic raw material can be fed to the screw 2 in granulate form or for instance in powder form or as chips.

The injection-moulding unit 1 further comprises dosing means 14 that comprise a dosing channel 10, dosing valve 11, additive container 12 and dosing pump 13.

The dosing channel 10 is connected to the cylinder 3 at a location where it opens into the space between the cylinder 3 and screw at the feed zone 4 of the screw 2. When arranging the dosing channel 10 in the cylinder 3, it should be noted that it should preferably not be arranged so far from the feed opening 9 as to have the compression zone 5 move there during the feed step.

In the embodiment shown in the figure, the dosing channel 10 comprises a dosing valve 11 that is attached to the cylinder 3. The dosing valve 11 is a check valve that prevents the plastic raw material from flowing into the dosing channel 10. The dosing valve 11 is, however, not always necessary.

At one end the dosing channel 10 is connected to the additive container 12 where the additive to be dosed is arranged. The dosing channel 10 also has a dosing pump 13 connected thereto that generates the required pressure for dosing the additive, which needs to be higher than the counter-pressure in the cylinder 3. It should be noted that the dosing pump 13 can also be located elsewhere, for instance in the additive container 12.

The dosing of the additive is scheduled so that the additive is fed among the plastic raw material only during the plasticizing step, and preferably in such a manner that the additive is fed among the plastic raw material during the entire plasticizing step. The dosing pump 13 is controlled with impulses or signals obtained on the basis of the movement or location of the screw 2. The generation of the pressure required in feeding the additive can be implemented in several ways, such as by starting the dosing pump 13 when the feeding is to start, and stopping it when the feeding is to stop, or in such a manner that the dosing pump 13 maintains in the container 12 and/or channel 10 a continuous pressure, and the dosing valve 11 is of a type that can be controlled to open to start the dosing and to close to stop the dosing.

The plasticizing step, which is also referred to as dosing step, is the step in the injection-moulding process where the screw 2 travels backward and moves the plastic raw material to its front for use during the next injection time. In the situation shown in FIG. 1, the injection-moulding unit 1 has just injected the melted or at least soft plastic raw material and with it the additive into the mould. It should be noted that the mould is not shown in the figures. The screw 2 has moved into its front position, which movement is shown by arrow F. After this, holding pressure is maintained in a manner known per se in the mould by means of the screw 2, if necessary.

FIG. 2 shows the next step, in which the screw 2 is pulled back, as shown by arrow B, and rotated, as shown by arrow R, in such a manner that the feed zone 4 of the screw moves the granulate arriving through the feed opening 9 onward toward the compression zone 5. The granulate is plasticized as it passes through the compression zone 5 and homogenization zone 6 to the front of the screw 2.

As earlier already stated, the additive is dosed into the plastic raw material during the plasticizing step. The amount of additive in the plastic raw material is kept very even, because the screw 2 moves an essentially constant amount of plastic raw material onward within a time unit and because the dosing of the additive for each time unit is also easy to keep constant. When the screw 2 has moved a sufficient amount of plasticized plastic raw material in front of it, as shown in FIG. 3, the backward movement and the rotation of the screw 2 is stopped, whereby the plasticizing step ends.

After the plasticizing step, the injection step is initiated, i.e. the screw 2 is pushed forward. The plasticized plastic raw material in front of the screw 2 flows into the mould. The backward flow of the plastic raw material is usually prevented with a back flow valve that is not shown in the figure. No additive is dosed into the plastic raw material during the injection step.

The fed additive is preferably liquid, for instance a lubricant that lowers the friction coefficient of the surface of the injection-moulded product. The lubricant is often paraffin or a mixture containing it, but lubricants of other type can also be used. One known lubricant that can be used in the invention is marketed by the trade name of Versapol.

The amount of additive is at most approximately 1 percentage by weight of the amount of the plastic raw material. In one embodiment of the invention, for instance, the plastic raw material is thermoplastic polyester (PCTG), and the additive is Versapol, the amount of which is at most 0.64 percentage by weight of the amount of the plastic raw material. The lubricant remains at least mainly on the surface of the component being manufactured and lowers the friction coefficient of the surface. Said component is a cylindrical part of a needle shield in which the component slides relative to a second cylindrical component out from it or vice versa. Both cylindrical components are preferably made with the method of the invention by using the injection-moulding unit of the invention.

However, it should be noted that the invention could also be applied with other thermoplastic plastic raw materials and with other additives than lubricants. The additive can for instance be a liquid colour agent or other additive dosed in liquid form. It is also clear that it is possible to dose more than one additive during one feed step. Each additive may have its own dosing means that is connected to the cylinder 3 in the manner shown above. It is also possible to mix two or more additives and feed them through a common dosing channel to the feed zone 4.

In some cases, the features presented in this application can be use as such regardless of other features. On the other hand, the features presented in this application can, if necessary, be combined to form various combinations.

The drawings and the related description are only intended to illustrate the idea of the invention. The invention may vary in detail within the scope of the claims.

1-6. (canceled)

7. A method for dosing an additive in an injection-moulding unit that comprises
a screw that is arranged to rotate and reciprocate in a cylinder and is divided in the longitudinal direction into a feed zone, compression zone and homogenisation zone, and
in a space between the screw and cylinder, the flow properties of a plastic raw material are plasticized to an appropriate level;
feed devices that dose the plastic raw material into the space between the screw and cylinder though a feed opening onto the feed zone of the screw; and
the injection-moulding unit has two main operational steps, i.e. a plasticizing step and injection step, and
in the plasticizing step, the screw is arranged to reverse in the cylinder and obtain in front of it a sufficient amount of the plastic raw material for the injection step, and
in the injection step, the screw advances pushing the plasticized raw material out of the cylinder; and the method comprising
feeding the additive to the feed zone of the screw from a dosing channel that opens into the space between the screw and cylinder after the feed opening in the flow direction of the plastic raw material, and
feeding as the additive a lubricant that lowers the friction coefficient of the surface of the injection-moulded product, and feeding the additive only during the plasticizing step.

8. An injection-moulding unit that comprises a screw arranged to rotate and reciprocate in a cylinder and comprising a feed zone,
feed devices that comprise a feed opening through which a plastic raw material is fed to a space between the screw and cylinder onto the feed zone of the screw,
the screw being arranged to move backward in the cylinder and to obtain in front of it a sufficient amount of the plasticized plastic raw material for the injection step, after which the screw is arranged to move onward in the cylinder and push the plastic raw material into an injection channel,
the injection-moulding unit comprising a dosing channel leading through a wall of the cylinder and arranged into the cylinder after the feed opening in the flow direction of the plastic raw material,
the dosing channel being connected to an additive container for feeding the additive to the feed zone of the screw, wherein the additive to be fed is a lubricant that lowers the friction coefficient of the surface of the injection-moulded product and that the dosing of the lubricant is scheduled in such a manner that it is fed only when the screw moves backward in the cylinder.

9. An injection-moulding unit as claimed in claim 8, wherein the additive to be fed is liquid.

10. An injection-moulding unit as claimed in claim 7, wherein the lubricant is paraffin or a mixture containing it.

11. An injection-moulding unit as claimed in claim 7, wherein the dosing channel comprises a dosing valve arranged to prevent the entry of the plastic raw material into the dosing channel.

12. An injection-moulding unit as claimed in claim 7, wherein the amount of additive is at most approximately 1 percentage by weight of the amount of the plastic raw material.
